(19) United States
(12) Patent Application Publication
(10) Pub. No.: US 2008/0285596 A1
(43) Pub. Date: Nov. 20, 2008

(54) SYSTEM AND METHOD FOR FINE-GRAINED, END-TO-END TRAFFIC SCHEDULING ACROSS HETEROGENEOUS LOCAL AREA NETWORKS

(76) Inventors: Frank Hady, Portland, OR (US); Kevin Stanton, Portland, OR (US)

Correspondence Address: INTEL CORPORATION;c/o INTELLEVATE, LLC, P.O. BOX 52050, MINNEAPOLIS, MN, 55402, US

(21) Appl. No.: 11/749,873

(22) Filed: May 17, 2007

(51) Int. Cl. H04J 3/06

(52) U.S. Cl. 370/503; 370/232

(57) ABSTRACT

A system and method for fine-grained, end-to-end traffic scheduling across heterogeneous local area networks (LANs). A system may include a network, where the network comprises multiple heterogeneous network, technologies. The system also may include at least two devices coupled to the network, where clocks of the at least two devices are synchronized. The system also may include a scheduler coupled to the network, where the scheduler creates a network wide data traffic schedule and where the data traffic schedule determines when each of the at least two devices can send data into the network. Other embodiments are described and claimed.

### BACKGROUND

The importance for the consumer electronic device industry to continuously strive to produce products that are easy to use cannot be overstated. No doubt this is one of the reasons for the introduction of the digital home network where one or more electronic devices are connected together in such a way as to provide a user with a means for entertainment via a home entertainment center and a single display device. But, there exists “quality of service” (QoS) problems with the digital home network.

Digital home networks are heterogeneous—constructed from a variety of different networking technologies including, but not limited to, Ethernet (IEEE 802.3 standard), Wireless (IEEE 802.11 standard) and Powerline (HomePlug AV (HPAV)). These networks are interconnected via the data link or layer 2 of the Open Systems Interconnection (OSI) stack (i.e., bridged and not routed). Each different network technology provides a different set of QoS features which do not map directly to each other (e.g., complex Hybrid Coordination Function (HCF) Controlled Channel Access (HCCA) protocol defined for the IEEE 802.11 standard and isochronous delivery implemented in HPAV, but without interoperability defined).

The transmission of high bandwidth video and audio data in the digital home network is common. The packet flows driven by these workloads are performance critical. Thus, long delays or dropped packets are immediately noticed by the end user as audio pops or video aberrations are often considered unacceptable.

In addition, digital home networks often operate near their saturation points. Multiple media flows can require high network throughputs. At the same time, some of the different networking technologies used in digital home networks have relatively low bandwidths.

Thus, the aforementioned QoS problems with the digital home network often result in unacceptable performance issues for many consumers.

### BRIEF DESCRIPTION OF THE DRAWINGS

FIG. 1 illustrates one embodiment of a digital home network.

FIG. 2 illustrates an exemplary scenario of data stream flows in a digital home network.

FIG. 3 illustrates one embodiment of a scheduler.

FIG. 4 illustrates one embodiment of a logic flow.

### DETAILED DESCRIPTION

Various embodiments may be generally directed to a system and method for fine-grained, end-to-end traffic scheduling across heterogeneous local area networks (LANs). In an embodiment, a network comprises multiple heterogeneous network technologies. Example heterogeneous network technologies include Ethernet. Wireless and Powerline network technologies. The clocks of devices attached to the network are synchronized. The IEEE standard of 802.1 AS time synchronization may be utilized to synchronize the clocks to within a few microseconds (10⁻⁶ seconds) of each other. A scheduler coupled to the network creates a network wide data traffic schedule. The data traffic schedule dictates when each of the devices in the network can send data into the network. The scheduler may be centralized, redundant, and/or distributed. In another embodiment, the devices attached to the network may decide, in a distributed fashion, which device can send data into the network and when. Other embodiments may be described and claimed.

Various embodiments may comprise one or more elements or components. An element may comprise any structure arranged to perform certain operations. Each element may be implemented as hardware, software, or any combination thereof, as desired for a given set of design parameters or performance constraints. Although an embodiment may be described with a limited number of elements in a certain topology by way of example, the embodiment may include more or less elements in alternate topologies as desired for a given implementation. It is worthy to note that any reference to “one embodiment” or “an embodiment” means that a particular feature, structure, or characteristic described in connection with the embodiment is included in at least one embodiment. The appearances of the phrase “in one embodiment” in various places in the specification are not necessarily all referring to the same embodiment.

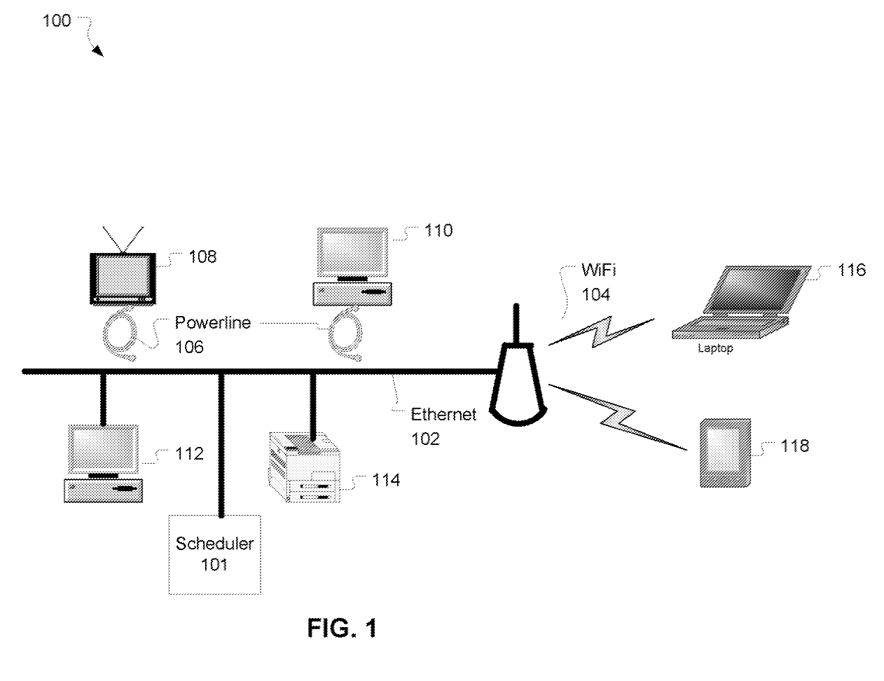

FIG. 1 illustrates one embodiment of a heterogeneous digital home network 100. Referring to FIG. 1, network 100 may include a variety of different networking technologies including, but not limited to, Ethernet 102, Wireless or WiFi 104 and/or Powerline 106. Various audio/visual devices, such as a television 108, a PC 110, a PC 112, a printer 114, a laptop 116 and a personal digital assistant (PDA) 118 are coupled to each other via Ethernet 102, WiFi 104 and/or Powerline 106 network technologies.

Local clocks across network 100 are synchronized. In an embodiment of the invention, the IEEE standard of 802.1AS time synchronization may be utilized to synchronize the clocks to within a few microseconds (10⁻⁶ seconds) of each other.

The endpoints or network interfaces across network 100 are enabled to accurately coordinate the injection of time-sensitive traffic into network 100. Here, each network interface maintains multiple prioritized and lime-indexed transmit, queues from which packets for transmission are selected based on their respective delivery requirement. The delivery requirements for each network interface are determined by a scheduler 101.

Scheduler 101 receives a request from one or more devices (e.g., device 108, 110, 112, 114, 116 and 118) when any of these devices wants to send a new data stream into network 100. The request is to reserve the needed bandwidth. With knowledge of all of the new data, stream requests in network 100, scheduler 101 creates a network wide data traffic schedule by either granting or denying each of the requests. Scheduler 101 may also consider such factors as runtime, application needs, and so forth, to generate the schedule. Thus, scheduler 101 facilitates fine grained allocation of network time as determined by new data stream requests throughout network 100, runtime, cross network application needs, and so forth. Hence, admission control is enabled across the entire heterogeneous network over the existing network infrastructure without requiring new heterogeneous layer-2 quality of service (QoS) features or isochronous support.

In an embodiment, when scheduler 101 grants the request, scheduler 101 returns a slot period identifier to the requesting device. The slot period identifier is used by the device to determine a slot start-time and stop-time in the network wide data traffic schedule to send its data over network 100. Scheduler 101 also informs all devices on network 100 of the left-over slot period by sending each of the devices a left-over slot period identifier. The left-over slot period is reserved for regular data traffic and new data stream requests.

With the data traffic schedule set, each device in network 100 with a granted new data stream request sends the slot period identifier to its endpoint or network interface. Each network interface uses its synchronized clock, transmit queues and time slot to accurately inject its data into network 100. In embodiments, network interfaces in network 100 are adapted to inject time sensitive data “at a particular time” into network 100. Here, since network 100 is reserved for that data stream flow, each device is assured of the needed bandwidth and the data transfers encounter no collisions or congestion. Each data stream flow is also assured of the periodicity (fitter) of sends required. Accordingly, many of the QoS issues that exist with today's heterogeneous digital home networks (or LANs in general) may be alleviated.

In addition, since switches in network 100 may also be made aware of the global synchronized clock time, switches might allow data flows from particular devices only during properly allocated times. This allows bandwidth reservation to function properly even if some of the network interfaces are not adapted to include the functionality of the invention described herein.

Some networks, such as wireless, are bandwidth variable networks. In embodiments, network time is dedicated to particular application flows. The rate at which the network operates varies the number of bits that can be transmitted in the reserved time slot. In embodiments, scheduler 101 is aware of network performance changes and adjusts the slot start and stop times for each active endpoint or network interface. Alternatively, if scheduler 101 does nothing in reaction to network performance changes then all data flows suffer or benefit equally.

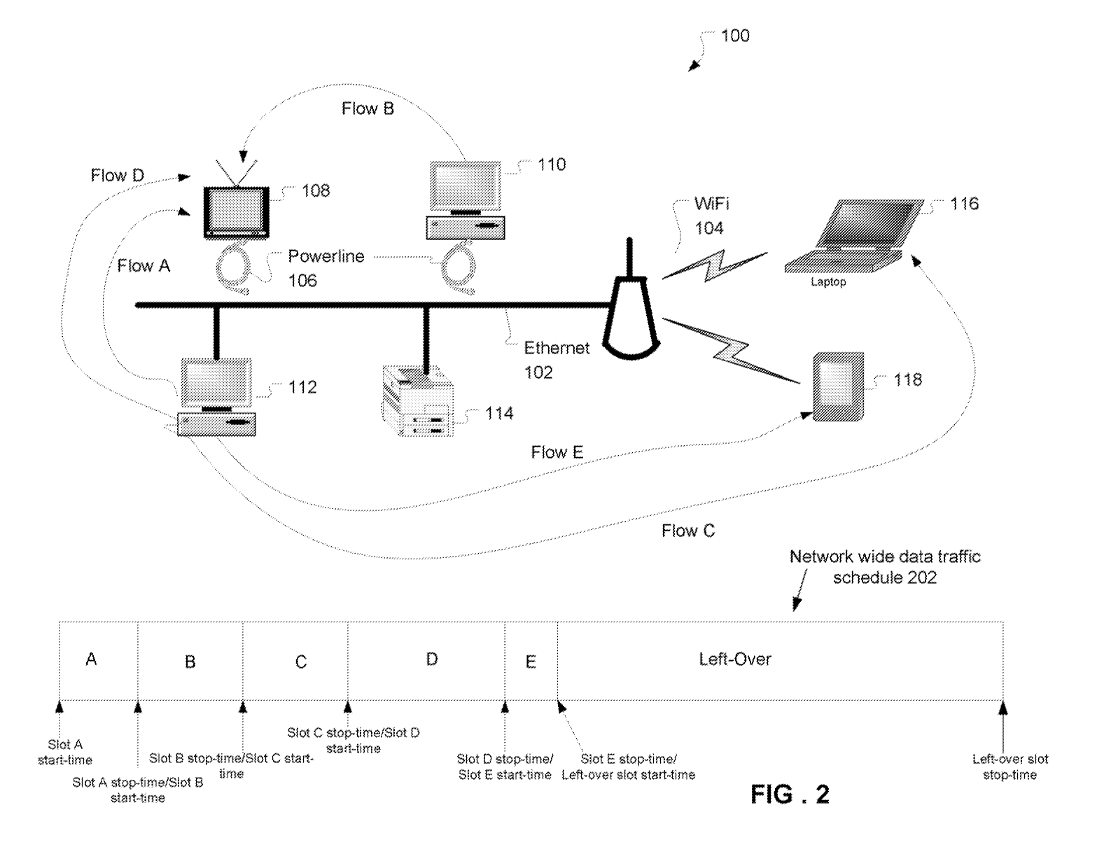

An exemplary scenario of data stream flows in digital home network 100 is illustrated in FIG. 2. Referring to FIG. 2, a network wide data traffic schedule 202 is shown. Schedule 202 represents six scheduled data flows, including flows A-E and a left-over flow. Schedule 202 also illustrates a start and stop-time for each data flow. For example, slot A is reserved for PC 112 to send data over network 100, slot B is reserved for PC 110 to send data over network 100, and so forth. The left-over slot is reserved for any of the devices to send regular data traffic and new data stream requests over network 100. The exemplary schedule 202 and data flows shown in FIG. 2 are not meant, to limit, the invention.

In various embodiments, network 100 may be implemented via wireless technologies, wired technologies, or a combination of both. The types of network technologies and devices shown in FIGS. 1 and 2 are provided for illustration purposes only and are not meant to limit the invention. Also note that although embodiments of the invention described herein refer to a digital home network, this is not meant to limit the invention. Network 100 may be any local area network (LAN).

The various devices illustrated in FIG. 1 may incorporate wireless functionality, wired functionality, or a combination of both. For example, when implemented with wireless functionality, a device may include components and interfaces suitable for communicating over a wireless shared media, such as one or more antennas, transmitters, receivers, transceivers, amplifiers, filters, control logic, and so forth. An example of wireless shared media may include portions of a wireless spectrum, such as the RF spectrum, and so forth. When implemented with wired functionality, a device may include components and interfaces suitable for communicating over wired communications media, such as input/output (I/O) adapters, physical connectors to connect, the I/O adapter with a corresponding wired communications medium, a network interface card (NIC), disc controller, video controller, audio controller, and so forth. Examples of wired communications media may include a wire, cable, metal leads, printed circuit board (PCB), backplane, switch fabric, semiconductor material, twisted-pair wire, co-axial cable, fiber optics, and so forth.

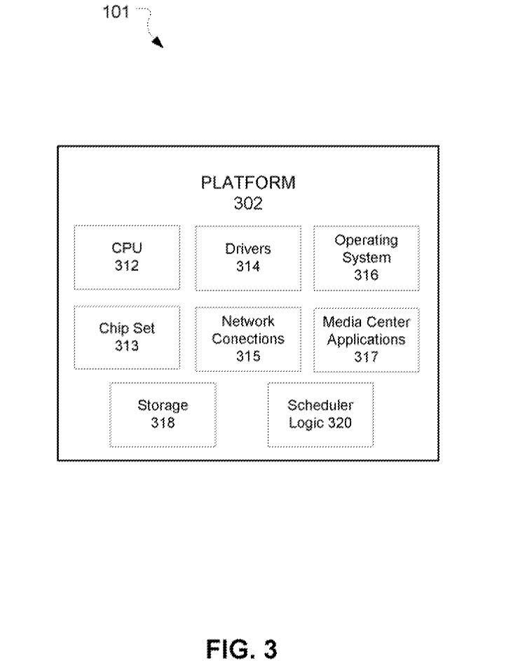

FIG. 3 illustrates an embodiment of scheduler 101. In one embodiment, scheduler 101 may comprise or may be implemented as a media platform 302 such as the Viiv™ media platform made by Intel® Corporation. In one embodiment, platform 302 may receive data flow requests from one or more of the devices in network 100.

In one embodiment, platform 302 may comprise a CPU 312, a chip set 313, one or more drivers 314, one or more network connections 315, an operating system 316, and/or one or more media center applications 317 comprising one or more software applications, for example. Platform 302 also may comprise storage 318 and scheduler logic 320.

In one embodiment, CPU 312 may comprise one or more processors such as dual-core processors. Examples of dual-core processors include the Pentium® D processor and the Pentium® processor Extreme Edition both made by Intel® Corporation, which may be referred to as the Intel Core Duo processors, for example.

In one embodiment, chip set 313 may comprise any one of or all of the Intel® 945 Express Chipset family, the Intel® 955X Express Chipset, Intel® 975X Express Chipset family, plus ICH7-DB or ICH7-MDH controller hubs, which all are made by Intel® Corporation.

In one embodiment, drivers 314 may comprise the Quick Resume Technology Drivers made by Intel® to enable users to instantly turn on and off platform 302 like a television with the touch of a button after initial boot-up, when enabled, for example. In addition, chip set 313 may comprise hardware and/or software support for 5.1 surround sound audio and/or high definition 7.1 surround sound audio, for example. Drivers 314 may include a graphics driver for integrated graphics platforms. In one embodiment, the graphics driver may comprise a peripheral component interconnect (PCI) Express graphics card.

In one embodiment, network connections 315 may comprise the PRO/1000 PM or PRO/100 VE/VM network connection, both made by Intel® Corporation.

In one embodiment, operating system 316 may comprise the Windows® XP Media Center made by Microsoft® Corporation. In one embodiment, one or more media center applications 317 may comprise a media shell to enable users to interact with a remote control from a distance of about 10-feet away from platform 302 or a display device, for example. In one embodiment, the media shell may be referred to as a “10-feet user interface,” for example. In addition, one or more media center applications 317 may comprise the Quick Resume Technology made by Intel®, which allows instant on/off functionality and may allow platform 302 to stream content to media adaptors when the platform is turned “off.”

In one embodiment, storage 318 may comprise the Matrix Storage technology made by Intel® to increase the storage performance enhanced protection for valuable digital media when multiple hard drives are included. In one embodiment, scheduler logic 320 enables the functionality of scheduler 101 as described herein. The embodiments, however, are not limited to the elements or in the context shown or described in FIG. 3.

Operations for the above embodiments may be further described with reference to the following figures and accompanying examples. Some of the figures may include a logic flow. Although such figures presented herein may include a particular logic flow, it can be appreciated that the logic flow merely provides an example of how the general functionality as described herein can be implemented. Further, the given logic flow does not necessarily have to be executed in the order presented unless otherwise indicated. In addition, the given logic flow may be implemented by a hardware element, a software element executed by a processor, or any combination thereof.

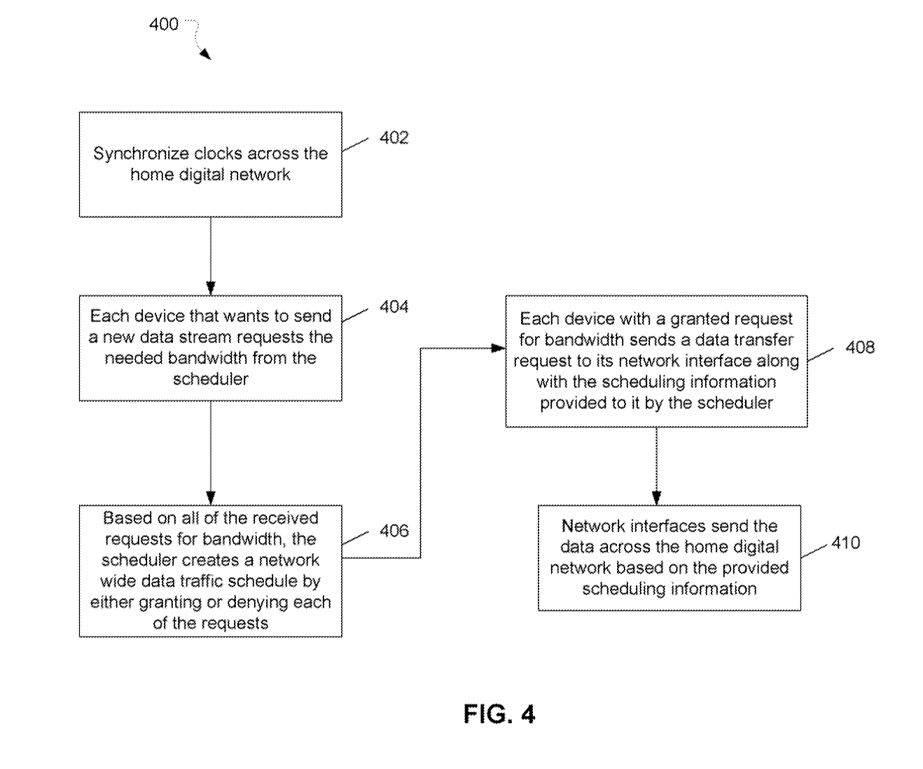

FIG. 4 illustrates one embodiment of a logic flow 400. As shown in logic flow 400, local clocks across network 100 are synchronized (block 402). As mentioned above and in an embodiment of the invention, the IEEE standard of 802.1AS time synchronization may be utilized to synchronize the clocks to within a few microseconds (10⁻⁶ seconds) of each other.

Each device that wants to send a new data stream into network 100 sends a request to scheduler 101 (block 404). With knowledge of all of the new data stream requests in network 100, scheduler 101 creates a network wide data traffic schedule by either granting or denying each of the requests (block 406). Scheduler 101 may consider other factors such as runtime, cross network application needs, and so forth, to generate the network wide data traffic schedule.

With the data traffic schedule set, each device in network 100 with a granted new data stream request sends the slot period identifier to its endpoint or network interface (block 408). Each network interface uses its synchronized clock, transmit queues and time slot in the data traffic schedule to accurately inject its time sensitive data into network 100 (block; 410). Embodiments of the invention, however, are not limited to the context shown or described in FIG. 4.

Various embodiments may be implemented using hardware elements, software elements, or a combination of both. Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor device, chips, microchips, chip sets, and so forth. Examples of software may include software components, programs, applications, computer programs, application programs, system programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. Determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints.

Some embodiments may be described using the expression “coupled” and “connected” along with their derivatives. These terms are not intended as synonyms for each other. For example, some embodiments may be described using the terms “connected” and/or “coupled” to indicate that two or more elements are in direct physical or electrical contact with each other. The term “coupled,” however, may also mean that two or more elements are not in direct contact with each other, but yet still co-operate or interact with each other.

Some embodiments may be implemented, for example, using a machine or tangible computer-readable medium or article which may store an instruction or a set of instructions that, if executed by a machine, may cause the machine to perform a method and/or operations in accordance with the embodiments. Such a machine may include, for example, any suitable processing platform, computing platform, computing device, processing device, computing system, processing system, computer, processor, or the like, and may be implemented using any suitable combination of hardware and/or software. The machine-readable medium or article may include, for example, any suitable type of memory unit, memory device, memory article, memory medium, storage device, storage article, storage medium and/or storage unit, for example, memory, removable or non-removable media, erasable or non-erasable media, writeable or re-writeable media, digital or analog media, hard disk, floppy disk. Compact Disk Read Only Memory (CD-ROM), Compact Disk Recordable (CD-R), Compact Disk Rewriteable (CD-RW), optical disk, magnetic media, magneto-optical media, removable memory cards or disks, various types of Digital Versatile Disk (DVD), a tape, a cassette, or the like. The instructions may include any suitable type of code, such as source code, compiled code, interpreted code, executable code, static code, dynamic code, encrypted code, and the like, implemented using any suitable high-level, low-level, object-oriented, visual, compiled and/or interpreted programming language.

Unless specifically stated otherwise, it may be appreciated that teens such as “processing,” “computing,” “calculating,” “determining,” or the like, refer to the action and/or processes of a computer or computing system, or similar electronic computing device, that manipulates and/or transforms data represented as physical quantities (e.g., electronic) within the computing system's registers and/or memories into other data similarly represented as physical quantities within the computing system's memories, registers or other such information storage, transmission or display devices. The embodiments are not limited in this context.

Numerous specific details have been set forth herein to provide a thorough understanding of the embodiments. It will be understood by those skilled in the art, however, that the embodiments may be practiced without these specific details. In other instances, well-known operations, components and circuits have not been described in detail so as not to obscure the embodiments. It can be appreciated that the specific structural and functional details disclosed herein may be representative and do not necessarily limit the scope of the embodiments.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

1. A method, comprising:
synchronizing clocks of all devices in a network, wherein the network comprises multiple heterogeneous network technologies; and
creating a network wide data traffic schedule, wherein the data traffic schedule to determine when each of the devices can send data into the network.

2. The method of claim 1, wherein the multiple heterogeneous network technologies include at least two of Ethernet, Wireless and Powerline network technologies.

3. The method of claim 1, wherein the data traffic schedule to reflect runtime and application needs considerations.

4. The method of claim 1, wherein synchronizing the clocks of the devices in the network is implemented via IEEE standard of 802.1AS time synchronization.

5. The method of claim 1, wherein the network is a local area network (LAN).

6. The method of claim 5, wherein the LAN is a home digital network.

7. The method of claim 1, further comprising:
adjusting at least one time slot duration in the data traffic schedule based on performance changes of the network.

8. A system, comprising:
a network, wherein the network; comprises multiple heterogeneous network technologies;
at least two devices coupled to the network, wherein clocks of the at least two devices are synchronized; and
a scheduler coupled to the network, wherein the scheduler to create a network wide data traffic schedule, and wherein the data traffic schedule to determine when each of the at least two devices can send data into the network.

9. The system of claim 8, wherein the multiple heterogeneous network technologies include at least two of Ethernet, Wireless and Powerline network technologies.

10. The system of claim 8, wherein the data traffic schedule to reflect runtime and application needs considerations.

11. The system of claim 8, wherein synchronizing the clocks of the devices in the network is implemented via IEEE standard of 802.1AS time synchronization.

12. The system of claim 8, wherein the network is a local area network (LAN).

13. The system of claim 12, wherein the LAN is a home digital network.

14. The system of claim 8, wherein the scheduler to adjust at least one time slot duration in the data traffic schedule based on performance changes of the network.

15. A machine-readable medium containing instructions which, when executed by a processing system, cause the processing system to perform a method, the method comprising:
synchronizing clocks of all devices in a network, wherein the network comprises multiple heterogeneous network technologies; and
creating a network wide data traffic schedule, wherein the data traffic schedule to determine when each of the devices can send data into the network.

16. The machine-readable medium of claim 15, wherein the multiple heterogeneous network technologies include at least two of Ethernet, Wireless and Powerline network technologies.

17. The machine-readable medium of claim 15, wherein the data traffic schedule to reflect runtime and application needs considerations.

18. The machine-readable medium of claim 15, wherein synchronizing the clocks of the devices in the network is implemented via IEEE standard of 802.1AS time synchronization.

19. The machine-readable medium of claim 15, wherein the network is a local area network (LAN).

20. The machine-readable medium of claim 15, further comprising:
adjusting at least one time slot duration in the data traffic schedule based on performance changes of the network.
